(19) United States
(12) Patent Application Publication
(10) Pub. No.: US 2017/0286616 A1
(43) Pub. Date: Oct. 5, 2017

(54) METHOD AND SYSTEM FOR IDENTIFYING OPTIMAL COMMUNICATION MODE AND HEALTH MANAGEMENT MODULES FOR PATIENT ENGAGEMENT

(71) Applicant: Wipro Limited, Bangalore (IN)

(72) Inventors: Shalini Sharad, West Windsor, NJ (US); Nitin Raizada, Edison, NJ (US); Bijendra Singhal, Bangalore (IN); Brijesh Sharma, New Delhi (IN)

(21) Appl. No.: 15/085,366

(22) Filed: Mar. 30, 2016

(30) Foreign Application Priority Data
Mar. 29, 2016 (IN) 201641010893

(51) Int. Cl. G06F 19/00

(52) U.S. Cl. CPC G06F 19/3418; G06F 19/325

(57) ABSTRACT

A method and a system for identifying optimal communication mode and health management modules for patient engagement includes receiving patient data from one or more data sources. Upon receiving the patient data, the patient engagement system determines a disease value for each of one or more diseases prevalent in a region, treatment value for each of the one or more diseases and technology value for each of the one or more technologies prevalent in the region. Based on the disease value and the treatment value, the patient engagement system determines one or more patient engagement modules and based on the technology value an optimal communication mode is determined. The one or more modules determined are provided to the patient through the optimal communication mode.

This application claims the benefit of Indian Patent Application Serial No. 201641010893 filed Mar. 29, 2016, which is hereby incorporated by reference in its entirety.

### FIELD

The present subject matter is related, in general to health management system, and more particularly, but not exclusively to a method and a system for identifying an optimal communication mode and one or more health management modules for patient engagement.

### BACKGROUND

In a healthcare technology landscape, a patient's engagement in healthcare contributes to improved health outcomes, and information technologies can further support engagement of the patients with the healthcare providers.

In the present digital era, patients are overwhelmed by the vast amount of health information and digital patient engagement models/modules. Such models are available online and involve applications, health and fitness wearables, etc. However, most of them are built with “one size fit for all” approaches i.e the same set of models is made available for all the patients. These models may not address or relate to the specific ailments of the patients, disease areas or nature of care. Also, these models have inherent limitations in accessing and using them. For example, while pharma and biotech companies are having existing solutions to support patients. However, they are not able to retain the enrolled patients through these set of models. The existing systems fail to motivate the enrolled patients to stay engaged with the solutions.

Dropping out of patients badly impact efficient monitoring and treatment of patients. Further, when such a fall out occurs in a large area or geography then the effectiveness of a healthcare program grossly reduces.

The issues mainly faced in the existing techniques are that, the patient engagement models involves “one size fit for all” approach which fails to change the behavior of the patient to keep the patient engaged in the healthcare program.

### SUMMARY

Disclosed herein is a method and system for identifying one or more health management modules and an optimal communication mode for patient engagement. Based on the patient data of a patient and the communication technology data of one or more technologies prevalent in the region, the system determines a disease score, a treatment score and a communication technology score. The disease score is determined based on parameters such as the type of the disease, severity of the disease, awareness of the disease to the patient and demography of the disease. The treatment score is determined based on parameters such as medication adherence of the patient, number of additional diseases to the patient and expenditure by the patient for treatment of the disease. The communication technology score is determined based on parameters such as the internet usage, smartphone usage and mobile phone usage in the region. Based on these score, the health management modules which are specific to the patients are identified and provided to them through an optimal communication mode.

Accordingly, the present disclosure relates to a method of identifying an optimal communication mode and one or more health management modules for patient engagement, the method comprises receiving, by a patient engagement system, patient data of one or more patients in a region and communication technology data of one or more communication technologies prevalent in the region from one or more data sources. Upon receiving the patient data, a disease score is determined for each of one or more diseases prevalent in the region based on one or more predefined first parameters associated with the patient data. Also, a treatment score is determined for each of the one or more diseases prevalent in the region based on one or more predefined second parameters associated with the patient data. The method further comprises determining a communication technology score based on one or more predefined third parameters associated with the communication technology data. Thereafter, one or more health management modules are identified based on the disease score and the treatment score and the optimal communication mode is identified based on the communication technology score for the patient engagement.

Further, the present disclosure relates to a system for identifying an optimal communication mode and one or more health management modules for patient engagement. The system receives patient data of one or more patients in a region and communication technology data of one or more communication technologies prevalent in the region from one or more data sources. Upon receiving the patient data, the system determines a disease score for each of one or more diseases prevalent in the region based on one or more predefined first parameters associated with the patient data. Also, the system determines a treatment score for each of the one or more diseases prevalent in the region based on one or more predefined second parameters associated with the patient data. Thereafter, the system determines a communication technology score based on one or more predefined third parameters associated with the communication technology data. Finally, the system identifies one or more health management modules based on the disease score and the treatment score and the optimal communication mode is identified based on the communication technology score for the patient engagement.

Furthermore, the present disclosure relates to a non-transitory computer readable medium including instructions stored thereon that when processed by at least one processor cause a patient engagement system to receive patient data of one or more patients in a region and communication technology data of one or more communication technologies prevalent in the region from one or more data sources. Upon receiving the patient data, the instructions further cause the system to determine a disease score for each of one or more diseases prevalent in the region based on one or more predefined first parameters associated with the patient data. Also, the system determines a treatment score for each of the one or more diseases prevalent in the region based on one or more predefined second parameters associated with the patient data. Thereafter, the instructions cause the system to determine a communication technology score based on one or more predefined third parameters associated with the communication technology data. Finally, the system identifies one or more health management modules based on the disease score and the treatment score and the optimal communication mode is identified based on the communication technology score for the patient engagement.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1a illustrates environment for identifying optimal communication mode and one or more health management modules for patient engagement in accordance with some embodiments of the present disclosure;

FIG. 1b shows a detailed block diagram illustrating a patient engagement system in accordance with some embodiments of the present disclosure;

FIG. 2 illustrates a flowchart showing a method for identifying optimal communication mode and one or more health management modules in accordance with some embodiments of the present disclosure; and

FIG. 3 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a system for identifying an optimal communication mode and one or more health management modules for patient engagement. The system receives patient data of one or more patients in a region and communication technology data of one or more communication technologies prevalent in the region from one or more data sources. Based on the patient data of a patient and the communication technology data of one or more technologies prevalent in the region, the system determines a disease score, a treatment score and a communication technology score. The disease score is determined based on parameters such as the type of the disease, severity of the disease, awareness of the disease to the patient and demography of the disease. The treatment score is determined based on parameters such as medication adherence of the patient, number of additional diseases to the patient and expenditure by the patient for treatment of the disease. The communication technology score is determined based on parameters such as the internet usage, smartphone usage and mobile phone usage in the region. Based on these score, the health management modules which are specific to the patients are identified and provided to them through an optimal communication mode.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

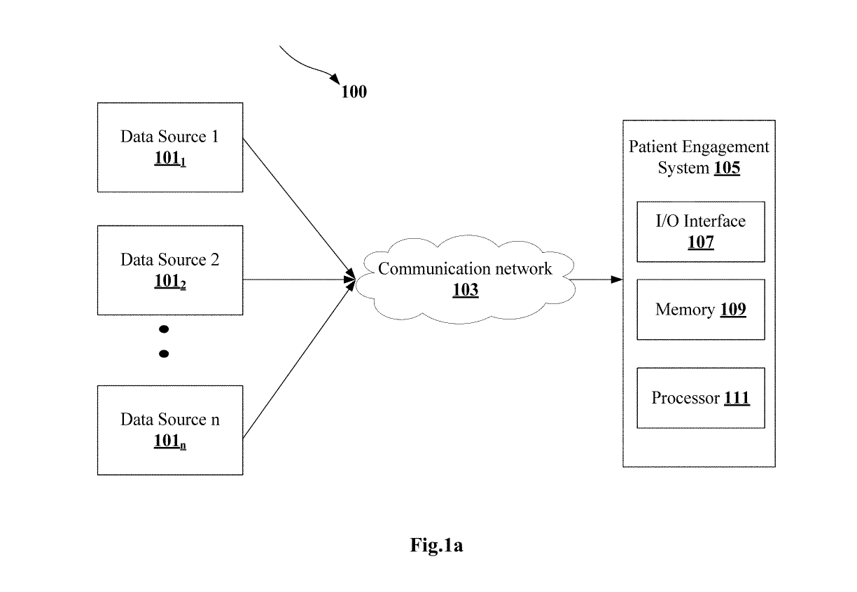

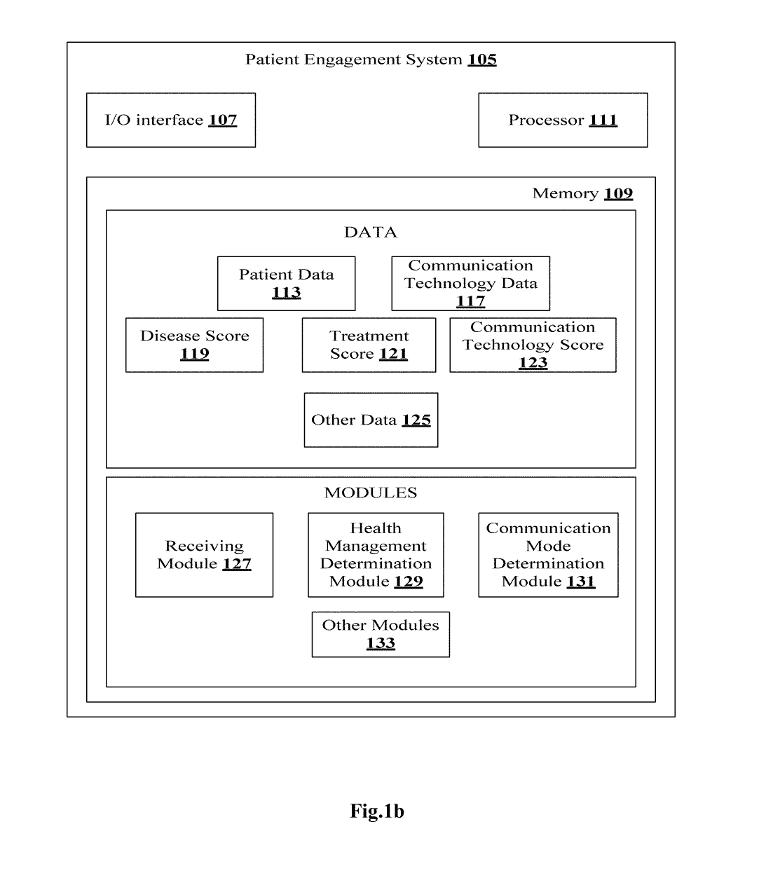

FIG. 1a illustrates environment for identifying optimal communication mode and one or more health management modules for patient engagement in accordance with some embodiments of the present disclosure.

The environment 100 comprises one or more data sources, data source 1 101₁ to data source n 101n (collectively referred as data sources 101), a communication network 103 and a patient engagement system 105 also in this example referred to as a patient engagement computing apparatus. As an example, the data source may include, but not limited to, an Electronic Health record (EHR), Electronic Medical Record (EMR) and public health systems. The EHR/EMR comprises data about patient or patient data such as demography of a patient, problems of the patient, information about one or more diseases being suffered by the patient, medications, past medical history, immunization, laboratory data and radiology reports. The public health systems comprise communication technology data such as health applications in smartphones, remote monitoring devices and patient portals. The data sources 101 provide the patient data and communication technology data to the patient engagement system 105 through the communication network 103. In an embodiment, the communication network 103 may be a wired or wireless communication network. The patient engagement system 105 comprises of an I/O interface 107, a memory 109 and a processor 111. The I/O interface 107 is configured to receive the patient data and the communication technology data from the one or more data sources 101. The received patient data and the communication technology data are stored in the memory 109. The processor 111 uses the patient data and the communication technology data for determining one or more health management modules and an optimal communication mode for providing the one or more health management modules for the patient engagement.

FIG. 1b shows a detailed block diagram illustrating a patient engagement system in accordance with some embodiments of the present disclosure.

In one implementation, the patient engagement system 105 stores the patient data 113 and the communication technology data 117 in the memory 109. In an embodiment, the patient engagement system 105 determines disease score 119, treatment score 121 and communication technology score 123 which are also stored in the memory 109 along with other data 125. In the illustrated FIG. 1b, one or more modules stored in the memory 109 are described herein in detail.

In one embodiment, the data may be stored in the memory 109 in the form of various data structures. Additionally, the aforementioned data can be organized using data models, such as relational or hierarchical data models. The other data 121 may store data, including temporary data and temporary files, generated by modules for performing the various functions of the patient engagement system 105.

In an embodiment, the patient data 113 comprises information about the patient such as patient name, age, location of the patient, medical history, treatment history, diseases being suffered by the patient, lifestyle of the patient, information about how the patient is doing between medical visits health progress, medications etc.

In an embodiment, the communication technology data 117 comprises information about the communication technologies being prevalent in the region. For example, the communication technologies may include but not limited to, internet, mobile applications, smartphone applications for patient engagement etc. The communication technologies are used for communicating with the patient or to keep the patient engaged with health monitoring applications.

In an embodiment, the disease score 119 is determined for each of the one or more diseases based on one or more predetermined first parameters. The one or more predefined first parameters are type of the disease, severity of the disease, awareness of the disease to the patient and demography of the patient. The type of the disease refers to whether the disease is chronic or acute. The chronic disease type refers to a condition where the disease lasts for 12 months or more than that and which meets the scenarios such as the disease places limitation on self-care, independent living and social interaction and the disease may result in the need for ongoing intervention with medical products, services and special equipment. The examples of the chronic diseases may include, but not limited to, diabetes and hypertension. The acute disease type refers to a condition where the disease duration is less than 12 months. The examples of the acute disease type may include, but not limited to, cold, influenza and strep throat. In an exemplary embodiment, if the type of the disease is chronic then the value assigned for the disease type is 1. If the type of the disease is acute, then the value assigned for the type of the disease is 0.10.

The severity of the disease indicates how sever the disease is. The mortality rate or death rate for a particular disease is the measure of proportion of the people being diagnosed with a disease who die during the course of the disease per unit of time. The indicator i.e mortality or death rate helps in identifying the severity of the disease. In an exemplary embodiment, if the life expectancy is less than a year after diagnosis of the disease then the value assigned for the disease severity is 1. If the life expectancy is between 1 to 3 years after diagnosis of the disease then the value assigned for the disease severity is 0.5. If the life expectancy is more than 3 years after diagnosis of the disease then the value assigned for the disease severity is 0.3.

The disease awareness refers to the extent of awareness/knowledge that the patient has on how to manage their disease, lifestyle, treatment and diet modifications which are necessary for the well-being of the patient. In an exemplary embodiment, if the patient is not well aware of the disease and its self-management then value assigned for disease awareness is 1. If the patient is aware of the disease but not aware of self-management of the disease then value assigned for disease awareness is 0.5. If the patient is aware of the disease and how to self-manage their conditions then the value assigned for disease awareness is 0.25.

The demography of the patient includes one or more attributes such as patient age, patient gender and ethnicity of the patient. In exemplary embodiment, the attribute “patient age” is considered. If the age of the patient is 14 or less than 14 then the value assigned for the demography of the patient is 0.1. If the age of the patient is in the range of 15-21 then the value assigned for the demography of the patient is 0.3. If the age of the patient is in the range of 21-55 then the value assigned for the demography of the patient is 0.7. If the age of the patient is more than 55 then the value assigned for demography of the patient is 1.

In an embodiment the disease score 119 is calculated based on the one or more predefined first parameters using a predefined first technique. Firstly, the value/score is assigned for each of the one or more predefined first parameters. Thereafter the disease value is calculated based on the score of each of the one or more predefined first parameters using a predefined first technique. The predefined first technique is as mentioned below in Equation 1.

Disease Value=(25%*Type of disease)+(25%*Disease severity value)+(25%*disease awareness value)+(25%*Patient demographics value) Equation (1).

The disease value is compared with one or more predefined disease value ranges. Each of the one or more disease value range is associated with a category and a disease score 119 as shown in Table 1 below.

TABLE 1

| Disease Value Range | Category | Disease Score |
|---|---|---|
| 1.00 to 0.75 | High | 1.0 |
| 0.75 to 0.50 | Medium | 0.75 |
| <0.5 | Low | 0.5 |

If the disease value obtained from equation (1) is less than 0.5 then the category assigned is “low” and the disease score 119 assigned is 0.5. If the disease value obtained from equation (1) is in the range of 0.5-0.75 then the category assigned is “medium” and the disease score 119 assigned is 0.75. If the disease value obtained from the equation (1) is in the range of 0.75-1 then the category assigned is “high” and the disease score 119 assigned is 1.

In an embodiment, the treatment score 121 is determined based on one or more predefined second parameters. The one or more predefined second parameters are medication adherence of the patient, number of additional diseases to the patient also referred as comorbid diseases and expenditure by the patient for treatment of the disease.

The predefined second parameter “medication adherence” means whether the patient is taking the medications correctly or not as prescribed by the doctors. This involves factors such as getting prescriptions filled, remembering to take medication on time and understanding the directions to use the medication. In an exemplary embodiment, if the medication adherence is less than 40% then the value assigned to the medication adherence is 1. If the medication adherence is more than 40% but less than 60% then value assigned for the medication adherence is 0.75. If the medication adherence is more than 60% but less than 80% then the value assigned for medication adherence is 0.50. If the medication adherence is more than 80% then the value assigned for medication adherence is 0.25.

The predefined second parameter “comorbid disease” means the number of diseases the patient has along with the disease for which medication is being taken. As an example, the patient who is being treated for hypertension may also have diabetes. So, the number of additional diseases is 1. As another example, if the patient who is being treated for hypertension has diabetes and dyslipidemia then the number of additional diseases is 2. In an exemplary embodiment, the value for the predefined second parameter “comorbid disease” is assigned based on the type of the disease and the severity of the disease.

As an example, if the number of comorbid disease is 1 then the value assigned for the comorbid disease is based on Equation 2 given below.

Value for Comorbid Disease=0.50*type of comorbid disease+disease severity value of the comorbid disease Equation (2)

If the number of comorbid disease is 2 then the value assigned for the comorbid disease is based on Equation 3 given below.

Value for Comorbid Disease=0.75*type of the comorbid disease+severity value of the comorbid disease Equation (3)

If the number of comorbid disease is 3 or more then the value assigned for the comorbid disease is based on equation 4 given below.

Value for Comorbid Disease=1*type of the comorbid disease+severity value of the comorbid disease Equation (4)

The predefined second parameter “expenditure by the patient for the treatment of the disease” is also referred as “medication copay”. In an exemplary embodiment, if the expenditure by the patient for the treatment is more than 80% then the value assigned for “medication co-pay” is 0.25. If the expenditure is in the range of 60% to 80% then the value assigned for the “medication co-pay” is 0.50. If the expenditure is in the range of 30% to 60% then the value assigned for “medication co-pay” is 0.75. If the expenditure is less than 30% then the value assigned for “medication co-pay” is 1.00.

In an embodiment the treatment score 121 is calculated based on the one or more predefined second parameters using a predefined second technique. Firstly, the value/score is assigned for each of the one or more predefined second parameters. Thereafter, the treatment value is calculated based on the score of each of the one or more predefined second parameters using a predefined second technique. The predefined second technique is as mentioned below in Equation 5.

Treatment Value=Medication Adherence (%)+number of comorbid disease+medication co-pay Equation (5)

The treatment value is compared with one or more predefined treatment value ranges. Each of the one or more predefined treatment value ranges is associated with a category and a treatment score 121 as shown in Table 2 below.

TABLE 2

| Treatment Value Range | Category | Treatment Score |
|---|---|---|
| 1.00 to 0.75 | High | 1.0 |
| 0.75 to 0.50 | Medium | 0.75 |
| <0.5 | Low | 0.5 |

If the treatment value obtained from Equation (5) is less than 0.5 then the category assigned is “low” and the treatment score 121 assigned is 0.5. If the treatment value obtained from equation (5) is in the range of 0.5-0.75 then the category assigned is “medium” and the treatment score 121 assigned is 0.75. If the treatment value obtained from the equation (2) is in the range of 0.75-1 then the category assigned is “high” and the treatment score 121 assigned is 1.

In an embodiment, the communication technology score 123 is determined based on one or more predefined third parameters. The one or more predefined third parameters are “internet usage”, “mobile usage” and smart phone usage”.

The internet usage refers to percentage of internet users in the country. In case the disease is specific in certain age group and/or gender, then the internet usage amongst the identified age group and/or gender would be considered. If the internet usage is greater than 75% then the value assigned for internet usage is 1.00. If the internet usage is in the range of 40% to 75% then the value assigned is 0.75. If the internet usage is less than 40% then the value assigned for internet usage is 0.50.

The mobile usage refers to percentage of mobile users in the country. In case the disease is specific in certain age group and/or gender, then the mobile usage amongst the identified age group and/or gender would be considered. If the mobile usage is greater than 75% then the value assigned for mobile usage is 1.00. If the mobile usage is in the range of 40% to 75% then the value assigned is 0.75. If the mobile usage is less than 40% then the value assigned for mobile usage is 0.50.

Similarly, the smart phone usage refers to percentage of smart phone users in the country. In case the disease is specific in certain age group and/or gender, then the smart phone usage amongst the identified age group and/or gender would be considered. If the smartphone usage is greater than 75% then the value assigned for smartphone usage is 1.00. If the smartphone usage is in the range of 40% to 75% then the value assigned is 0.75. If the smartphone usage is less than 40% then the value assigned for smartphone usage is 0.50.

In an embodiment the communication technology score 123 is calculated based on the one or more predefined third parameters using a predefined third technique. Firstly, the value/score is assigned for each of the one or more predefined third parameters. Thereafter, the communication technology score 123 is calculated based on the score of each of the one or more predefined third parameters using a predefined third technique. The predefined third technique is as mentioned below in Equation 6.

Communication Technology Score=Internet usage*Mobile usage*Smart Phone usage Equation (6)

In one implementation, the modules may include, for example, receiving module 127, health management determination module 129, communication mode determination module 131 and other modules 135. The other modules 135 may be used to perform various miscellaneous functionalities of the patient engagement system 105. It will be appreciated that such aforementioned modules may be represented as a single module or a combination of different modules.

In an embodiment, the receiving module 127 may be configured to receive the patient data 113 and communication technology data 117 from the one or more data sources 101. The patient data 113 comprises information about the patient such as patient name, age, location of the patient, medical history, treatment history, diseases being suffered by the patient, lifestyle of the patient, information about how the patient is doing between medical visits health progress, medications. The communication technology data 117 comprises information about the communication technologies being prevalent in the region.

In an embodiment, the health management determination module 129 may be configured to determine one or more health management modules for patient engagement. The health management determination module 129 determines the one or more health management modules specific to the patient based on the disease score 119 and the treatment score 121 identified for a particular patient.

In an embodiment, the communication mode determination module 131 may be configured to determine an optimal communication mode for communicating the health management modules for the patient engagement.

As an example, two patients namely “Patient A” and “Patient B” are considered for identifying the health management modules which are best suited for them and the communication mode for communicating the health management modules.

The receiving module 127 receives patient data 113 related to the “Patient A” from the one or more data sources 101 such as EMR and public health system. The patient data 113 received about “Patient A” are type of the disease being suffered by “Patient A” i.e diabetes, location of “Patient A” i.e India, awareness of the disease to the “Patient A” i.e low since “Patient A” is not aware of the disease and its self-management, medication adherence of “Patient A” i.e medication adherence is in the range of 35%-45% since “Patient A” misses medication dosage quite often and the expenditure for treatment of diabetes is spent completely by “Patient A”.

The health management determination module 129 determines disease score 119 and treatment score 121 based on the patient data 113 of “Patient A”.

The disease score 119 is determined by assigning a score/value for each of one or more predefined first parameters associated with the patient. The predefined first parameters are disease type, severity of the disease, awareness of the disease to the patient and demography of the patient. Since, “Patient A” is suffering from the disease “diabetes” the type of the disease is chronic and hence the value assigned for the first parameter, type of the disease is 1. The severity of the disease depends on the life expectancy. The life expectancy for the disease “diabetes” is more than 3 years after diagnosis. Therefore, the value assigned to the first parameter, severity of the disease is 0.3. The awareness of the disease to the patient is low.

Therefore, the value assigned for the first parameter, awareness of the disease is 1. The age of patient A is 45 which fall under the adult category and hence the value assigned for the first parameter “demography of the patient is 0.7.

The disease value for the “Patient A” is calculated based on the equation (1) as provided below.

Disease Value=(25%*Type of disease)+(25%*Disease severity value)+(25%*disease awareness value)+(25%*Patient demographics value).

$$Disease value for Patient A = 25 \% * 1 + 25 \% * 0.3 + 25 \% * 1 + 25 \% * 0.7 = 0.75$$

The disease value is compared with one or more predefined disease value ranges as mentioned in the Table 1. The Table 1 is provided below.

TABLE 1

| Disease Value Range | Category | Disease Score |
|---|---|---|
| 1.00 to 0.75 | High | 1.0 |
| 0.75 to 0.50 | Medium | 0.75 |
| <0.5 | Low | 0.5 |

Since the disease value “0.75” falls under the range “1.00 to 0.75” the disease score 119 identified for the “Patient A” is 1.0 and the category is high.

In an embodiment, the health management determination module 129 also determines the treatment score 121 upon receiving the patient data 113. The one or more predefined second parameters considered for the determination of the treatment score 121 are medication adherence, number of comorbid disease and the medication co-pay.

The health management determination module 129 assigns a value for each of the one or more predefined second parameters based on the received patient data 113. The value assigned for the second parameter, medication adherence is 1 since “Patient A” misses medication dosage quite often and hence falls under the category 35-40%. The value assigned for the second parameter, number of comorbid disease is 0 since the “Patient A” does not suffer with any other diseases along with diabetes. The value assigned for the second parameter, medication co-pay is 1 since expenditure of the “Patient A” for treatment of the disease is less than 30%.

The health management determination module 129 determines treatment value based on the equation (5) as provided below.

Treatment Value=Medication Adherence (%)+number of comorbid disease+medication co-pay.

$$Treatment Value for Patient A = 33.3 \% * 1 + 33.3 \% * 0 + 33.3 \% * 0.25 = 0.41$$

The treatment value is compared with one or more predefined treatment value ranges as mentioned in the Table 2 below.

TABLE 2

| Treatment Value Range | Category | Treatment Score |
|---|---|---|
| 1.00 to 0.75 | High | 1.0 |
| 0.75 to 0.50 | Medium | 0.75 |
| <0.5 | Low | 0.5 |

Since the treatment value is less than 0.5, the treatment score 121 identified for the “Patient A” is 0.5 and the category is low.

Similarly, the disease score 119 and the treatment score 121 are identified for the “Patient B” as illustrated below.

The receiving module 127 receives the patient data 113 related to the “Patient B” from the one or more data sources 101 such as EMR and public health system. The patient data 113 received about the “Patient B” are type of the disease being suffered by “Patient B” i.e diabetes and hypertension, location of the “Patient B” i.e United States of America, awareness of the disease to the “Patient B” i.e medium since “Patient B” is aware of the disease but not of its self-management, medication adherence of the “Patient B” is 60%.

The health management determination module 129 assigns a value for each of the one or more predefined first parameters. The predefined first parameters are disease type, severity of the disease, awareness of the disease to the patient and demography of the patient. Since, Patient B is suffering from the disease “diabetes” the type of the disease is chronic and hence the value assigned for the first parameter, type of the disease is 1. The severity of the disease “diabetes” depends on the life expectancy. The life expectancy for the disease “diabetes” is more than 3 years after diagnosis. Therefore, the value assigned to the first parameter, severity of the disease is 0.3. The awareness of the disease to the patient is medium. Therefore, the value assigned for the first parameter, awareness of the disease is 0.5. The age of patient B is 56 which fall under the category “old” and hence the value assigned for the first parameter, demography of the patient is 1.

The disease value for patient B is calculated based on the equation (5) as provided below.

Disease Value=(25%*Type of disease)+(25%*Disease severity value)+(25%*disease awareness value)+(25%*Patient demographics value).

$$Disease value for Patient B = 25 \% * 1 + 25 \% * 0.3 + 25 \% * 1 + 25 \% * 0.7 = 0.7$$

The disease value is compared with one or more predefined disease value ranges as mentioned in the Table 1 below.

TABLE 1

| Disease Value Range | Category | Disease Score |
|---|---|---|
| 1.00 to 0.75 | High | 1.0 |
| 0.75 to 0.50 | Medium | 0.75 |
| <0.5 | Low | 0.5 |

Since the disease value falls under the range “0.75 to 0.50” the disease score 119 identified for Patient B is 0.75 and the category is Medium.

The health management determination module 129 assigns a value for each of the one or more predefined second parameters based on the received patient data 113. The value assigned for the second parameter, medication adherence is 0.75 since medication adherence for patient B is 60%. The value assigned for the second parameter, number of comorbid disease is 2 since the “Patient B” is suffering with hypertension along with diabetes. So the number of the comorbid disease is 2 and hence the value assigned is 0.65. The value assigned for the second parameter, medication co-pay is 1 since expenditure of the “Patient B” for the medical expenses is less than 30%.

The health management determination module 129 determines treatment value based on the equation (5) as provided below.

Treatment Value=Medication Adherence (%)+number of comorbid disease+medication co-pay.

$$Treatment Value for Patient B = 33.3 \% * 1 + 33.3 \% * 0.3 + 33.3 \% * 0.5 + 25 \% * 1.0 = 0.80$$

The treatment value is compared with one or more predefined treatment value ranges as mentioned in the Table 2 below.

TABLE 2

| Treatment Value Range | Category | Treatment Score |
|---|---|---|
| 1.00 to 0.75 | High | 1.0 |
| 0.75 to 0.50 | Medium | 0.75 |
| <0.5 | Low | 0.5 |

Since the treatment value fall under the range “1.00 to 0.75”, the treatment score 121 identified for Patient B is 1 and the category is high.

In an embodiment, the communication mode determination module 131 determines the communication technology score 123 based on the communication technology data 117. The one or more parameters considered for the determination of the communication score are internet usage, mobile usage and smartphone usage.

Based on the communication technology data 117 received for the “Patient A”, the internet usage in the location of the “Patient A” is 15%. Therefore, the communication technology value assigned for the internet usage is 0.5. Similarly, the mobile usage is more than 80% therefore, the value assigned for the mobile usage is 1.0 and the smartphone usage is less than 40%. Therefore, the score assigned for the smartphone usage is 0.5.

The communication technology score=internet usage*mobile usage*smart phone usage.

$$The communication technology score for Patient A = 0.5 * 1.0 * 0.5 = 0.25$$

Based on the communication technology data 117 received for the “Patient B”, the internet usage in the location of patient B is 75%. Therefore, the communication technology value assigned for the internet usage is 1.0. Similarly, the mobile usage is more than 80% therefore, the value assigned for the mobile usage is 1.0 and the smartphone usage is 70%. Therefore, the score assigned for the smartphone usage is 1.

The communication technology score=internet usage*mobile usage*smart phone usage.

$$The communication technology score for Patient B = 1.0 * 1.0 * 1.0 = 1.0$$

In an embodiment, the patient engagement system 105 provides one or more solutions based on the score identified for treatment, disease and communication technology. An exemplary solution categories are provided in the below Table 3. The solution categories may refer to the type of applications for health management and the type of communication modes used for communicating the one or more health management modules.

TABLE 3

| | | Internet | |
|---|---|---|---|
| | | Usage * | |
| | Disease | Mobile | |
| | Score + | Usage* | Communication mode |
| Solution | Treatment | Smart Phone | and one or more health |
| Categories | Score | Usage | management modules |
| Category 1 | Between 2.0 to | =1.0 | All the modules of health |
| | 1.5 | | management will be |
| | | | delivered through smart |
| | | | phone based health |
| | | | application |
| Category 2 | Between 2.0 to | Less than 1 | All the modules of |
| | 1.5 | but greater | health management will |
| | | than 0.500 | be delivered through |
| | | | Web based health |
| | | | application + Mobile |
| | | | based health application + |
| | | | Smart phone based |
| | | | health application |
| Category 3 | Between 2.0 to | Less than | All the modules of health |
| | 1.5 | 0.500 but | management will be |
| | | greater than | delivered through Web |
| | | 0.20 | based health application + |
| | | | Mobile based health |
| | | | application |
| Category 4 | Between 2.0 to | Less than | All the modules of health |
| | 1.5 | 0.20 | management will be |
| | | | delivered through Web |
| | | | based health application + |
| | | | Mobile based health |
| | | | application + telehealth |
| Category 5 | Between 1.5 to | =1.0 | Deliver patient |
| | 1.0 | | adherence, patient |
| | | | assistance and patient |
| | | | education module though |
| | | | smart phone based health |
| | | | application |
| Category 6 | Between 1.5 to | Less than 1 | Deliver patient |
| | 1.0 | but greater | adherence, patient |
| | | than 0.500 | assistance and patient |
| | | | education module |
| | | | through Web based |
| | | | health application + |
| | | | Mobile based health |
| | | | application + Smart |
| | | | phone based health |
| | | | application |
| Category 7 | Between 1.5 to | Less than | Deliver patient |
| | 1.0 | 0.500 but | adherence, patient |
| | | greater than | assistance and patient |
| | | 0.20 | education module |
| | | | through Web based |
| | | | health application + |
| | | | Mobile based health |
| | | | application |
| Category 8 | Between 1.5 to | Less than | Deliver patient |
| | 1.0 | 0.20 | adherence, patient |
| | | | assistance and patient |
| | | | education module |
| | | | through Web based |
| | | | health application + |
| | | | Mobile based health |
| | | | application + telehealth |
| Category 9 | Less than 1.0 | =1.0 | Deliver patient |
| | | | engagement module |
| | | | though smart phone |
| | | | based health application |
| Category 10 | Less than 1.0 | Less than 1 | Deliver patient |
| | | but greater | engagement module |
| | | than 0.500 | through Web based |
| | | | health application + |
| | | | Mobile based health |
| | | | application + Smart |
| | | | phone based health |
| | | | application |
| Category 11 | Less than 1.0 | Less than | Deliver patient |
| | | 0.500 but | engagement module |
| | | greater than | through Web based |
| | | 0.20 | health application + |
| | | | Mobile based health |
| | | | application |
| Category 12 | Less than 1.0 | Less than | Deliver patient |
| | | 0.20 | engagement module |
| | | | through Web based |
| | | | health application + |
| | | | Mobile based health |
| | | | application + telehealth |

The one or more health management modules provided for the “Patient A” and “Patient B” is shown in the Table 4 below.

TABLE 4

| | | Internet | | |
|---|---|---|---|---|
| | | Usage * | | |
| | | Mobile | | Communication |
| | Disease | Usage* | | mode and one or |
| | Score + | Smart | | more health |
| | Treatment | Phone | Solution | management |
| Name | Score | Usage | Categories | modules |
| Patient A | 1.0 + 0.5 = 1.5 | 0.25 | Category 8 | Deliver patient |
| | | | | adherence, patient |
| | | | | assistance and |
| | | | | patient education |
| | | | | module through |
| | | | | Web + Mobile |
| | | | | application + |
| | | | | telehealth |
| Patient B | 0.75 + 1 = 1.75 | 1.0 | Category 1 | All the modules of |
| | | | | patient engagement |
| | | | | delivered through |
| | | | | smart phone based |
| | | | | health application |

Since Patient A fall under category 8, the one or more health management modules provided to Patient A are patient adherence, patient assistance and patient education modules through web based health application, mobile based health application and telehealth.

Similarly, Patient B falls under category 1. Therefore, the one or more health management modules provided to patient B are all the health management modules through smartphone based health application.

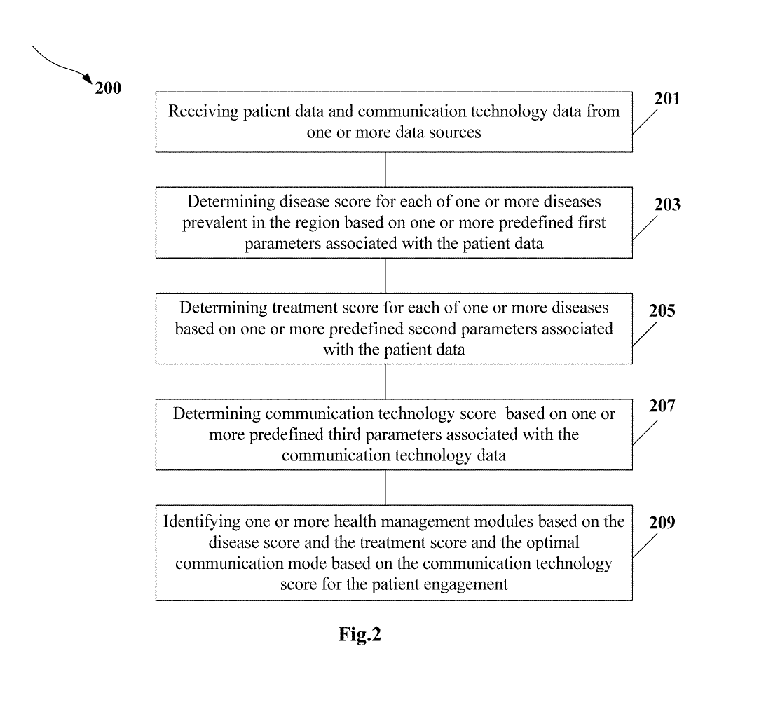

FIG. 2 illustrates a flowchart showing a method for identifying optimal communication mode and one or more health management modules in accordance with some embodiments of the present disclosure.

As illustrated in FIG. 2, the method 200 may comprise one or more blocks for identifying optimal communication mode and one or more health management modules using a patient engagement system 105. The method 200 may be described in the general context of computer executable instructions. Generally, computer executable instructions can include routines, programs, objects, components, data structures, procedures, modules, and functions, which perform particular functions or implement particular abstract data types.

The order in which the method 200 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof

At block 201, the patient data 113 and communication technology data 117 may be received from one or more data sources 101. The one or more data sources 101 may include, but not limited to, Electronic Health record (EHR), Electronic Medical Record (EMR) and public health systems. The EHR/EMR comprises patient data 113 such as demography of a patient, problems of the patient, information about the diseases being suffered by the patient, medications, past medical history, immunization, laboratory data and radiology reports. The public health systems comprise communication technology data 117 such as health applications in smartphones, remote monitoring devices and patient portals.

At block 203, a disease score 119 is determined for each of one or more diseases prevalent in the region. The disease score 119 is determined based on one or more predefined first parameters associated with the patient data 113. The one or more predefined first parameters are type of disease, severity of the disease, awareness of the disease to the patient and demography of the patient. The disease score 119 is assigned for each of these parameters. Thereafter the disease value is calculated based on the score of each of the one or more predefined first parameters using a predefined first technique. The disease value is compared with one or more predefined disease value ranges. Each of the one or more disease value range is associated with a category and a disease score 119. The disease score 119 corresponding to the matched predefined disease value range is obtained as the final disease score 119.

At block 205, a treatment score 121 is determined for each of the one or more diseases. The treatment score 121 is determined based on one or more predefined second parameters associated with the patient data 113. The one or more predefined second parameters are medication adherence, number of comorbid diseases and medication co-pay. The treatment score 121 is assigned for each of these parameters. Thereafter the treatment value is calculated based on the score of each of the one or more predefined second parameters using a predefined second technique.

The treatment value is compared with one or more predefined treatment value ranges. Each of the one or more treatment value range is associated with a category and a treatment score 121. The treatment score 121 corresponding to the matched predefined treatment value range is obtained as the final treatment score 121.

At block 207, a communication technology score 123 is determined based on one or more predefined third parameters associated with the communication technology data 117. The one or more predefined third parameters are internet usage, mobile phone usage and smartphone usage. A score is assigned to each of the one or more predefined third parameters. Thereafter, the communication technology score 123 is determined based on the score of each of the one or more predefined third parameters using a predefined third technique.

At block 209, the patient engagement system 105 determines one or more health management modules based on the disease score 119 and the treatment score 121. The patient engagement system 105 determines the communication technology for communicating the one or more health management modules based on the communication technology score 123.

### Computer System

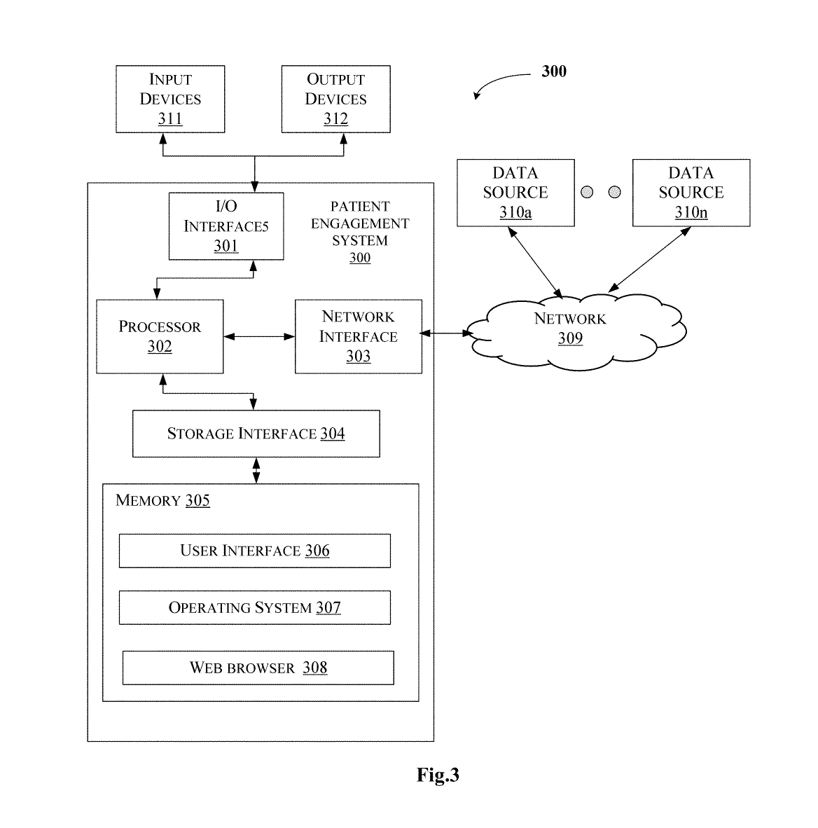

FIG. 3 illustrates a block diagram of an exemplary patient engagement system 300 also known as a patient engagement computing apparatus in this example for implementing embodiments consistent with the present invention. In an embodiment, the patient engagement system 300 is used to recommend one or more gestures to a user interacting with a computing device. The patient engagement system 300 may comprise a central processing unit (“CPU” or “processor”) 302. The processor 302 may comprise at least one data processor for executing program components for executing user- or system-generated business processes. A user may include a person, a person using a device such as such as those included in this invention, or such a device itself. The processor 302 may include specialized processing units such as integrated system (bus) controllers, memory management control units, floating point units, graphics processing units, digital signal processing units, etc.

The processor 302 may be disposed in communication with one or more input/output (I/O) devices (311 and 312) via I/O interface 301. The I/O interface 301 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 301, the patient engagement system 300 may communicate with one or more I/O devices (311 and 312).

In some embodiments, the processor 302 may be disposed in communication with a communication network 309 via a network interface 303. The network interface 303 may communicate with the communication network 309. The network interface 303 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 303 and the communication network 309, the patient engagement system 300 may communicate with one or more sensors 310 (a, . . . , n). The communication network 309 can be implemented as one of the different types of networks, such as intranet or Local Area Network (LAN) and such within the organization. The communication network 309 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 309 may include a variety of network devices, including routers, bridges, servers, computing devices, storage devices, etc. The one or more sensors 310 (a, . . . , n) may include, without limitation, a proximity sensor, image capturing device, radar and Infrared muscle contraction sensor.

In some embodiments, the processor 302 may be disposed in communication with a memory 305 (e.g., RAM, ROM, etc. not shown in FIG. 3) via a storage interface 304. The storage interface 304 may connect to memory 305 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 305 may store a collection of program or database components, including, without limitation, user interface application 306, an operating system 307, web server 308 etc. In some embodiments, patient engagement system 300 may store user/application data 306, such as the data, variables, records, etc. as described in this invention. Such databases may be implemented as fault-tolerant, relational, scalable, secure databases such as Oracle or Sybase.

The operating system 307 may facilitate resource management and operation of the patient engagement system 300. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. User interface 306 may facilitate display, execution, interaction, manipulation, or operation of program components through textual or graphical facilities. For example, user interfaces may provide computer interaction interface elements on a display system operatively connected to the patient engagement system 300, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the patient engagement system 300 may implement a web browser 308 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the patient engagement system 300 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the patient engagement system 300 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein.

In an embodiment, the present disclosure provides a method and system for identifying one or more communication modules and an optimal communication mode for patient engagement.

In an embodiment, the present disclosure provides specific modules to the patient through the optimal communication mode based on the patient data corresponding to the patient. Therefore, the level of dropping of the patient from any healthcare program is reduced.

In an embodiment, the present disclosure aids in changing the behavior of the patient to keep the patient engaged in the healthcare program.

In an embodiment, the present disclosure provides a personalized system for each patient based on the needs of the patient.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of identifying an optimal communication mode and one or more health management modules for patient engagement, the method comprising:
receiving, by a patient engagement computing apparatus, patient data of one or more patients in a region and communication technology data of one or more communication technologies prevalent in the region from one or more data sources;
determining, by the patient engagement computing apparatus, a disease score for each of one or more diseases prevalent in the region based on one or more predefined first parameters associated with the patient data;
determining, by the patient engagement computing apparatus, a treatment score for each of the one or more diseases prevalent in the region based on one or more predefined second parameters associated with the patient data;
determining, by the patient engagement computing apparatus, a communication technology score based on one or more predefined third parameters associated with the communication technology data; and
identifying, by the patient engagement computing apparatus, one or more health management modules based on the disease score and the treatment score and the optimal communication mode based on the communication technology score for the patient engagement.

2. The method as claimed in claim 1, wherein the one or more predefined first parameters are type of disease, severity of the disease, awareness of the disease to the patient or demography of the patient.

3. The method as claimed in claim 1, wherein the one or more predefined second parameters are medication adherence of the patient, number of additional diseases to the patient or expenditure by the patient for treatment of the disease.

4. The method as claimed in claim 1, wherein the one or more predefined third parameters are internet usage, smartphone usage or mobile phone usage.

5. The method as claimed in claim 1, wherein the determining the disease score comprises:
assigning, by the patient engagement computing apparatus, a score for each of the one or more predefined first parameters;
computing, by the patient engagement computing apparatus, a disease value based on the score of each of the one or more predefined first parameters using a predefined first technique;
comparing, by the patient engagement computing apparatus, the disease value with each of one or more predefined disease value ranges, wherein each of the one or more predefined disease value ranges is associated with a category and a disease score; and
obtaining, by the patient engagement computing apparatus, the disease score corresponding to the matched predefined disease value range.

6. The method as claimed in claim 1, wherein the determining the treatment score further comprises:
assigning, by the patient engagement computing apparatus, a score for each of the one or more predefined second parameters;
computing, by the patient engagement computing apparatus, a treatment value based on the score of each of the one or more predefined second parameters using a predefined second technique;
comparing, by the patient engagement computing apparatus, the treatment value with each of one or more predefined treatment value ranges, wherein each of the one or more predefined treatment value ranges is associated with a category and a treatment score; and
obtaining, by the patient engagement computing apparatus, the treatment score corresponding to the matched predefined treatment value range.

7. The method as claimed in claim 1, wherein the determining the communication technology score further comprises:
assigning, by the patient engagement computing apparatus, a score for each of the one or more predefined third parameters;
computing, by the patient engagement computing apparatus, a communication technology value based on the score of each of the one or more predefined third parameters using a predefined third technique;
comparing, by the patient engagement computing apparatus, the communication technology value with each of one or more predefined communication technology value ranges, wherein each of the one or more predefined communication technology value ranges is associated with a category and a communication technology score; and
obtaining, by the patient engagement computing apparatus, the communication technology score corresponding to the matched predefined communication technology value range.

8. A patient engagement system for identifying an optimal communication mode and one or more health management modules for patient engagement, the system comprising:
at least one processor; and
a memory storing instructions executable by the at least one processor, wherein the instructions configure the at least one processor to:
receive patient data of one or more patients in a region and communication technology data of one or more technologies prevalent in the region from one or more data sources;
determine a disease score for each of one or more diseases prevalent in the region based on one or more predefined first parameters associated with the patient data;
determine a treatment score for each of the one or more diseases prevalent in the region based on one or more predefined second parameters associated with the patient data;
determine a communication technology score based on one or more predefined third parameters associated with the communication technology data; and
identify one or more health management modules based on the disease score and the treatment score and the optimal communication mode based on the communication technology score for the patient engagement.

9. The system as claimed in claim 8, wherein the one or more predefined first parameters are type of disease, severity of the disease, awareness of the disease to the patient or demography of the patient.

10. The system as claimed in claim 8, wherein the one or more predefined second parameters are medication adherence by the patient, number of additional diseases to the patient or expenditure by the patient for treatment of the disease.

11. The system as claimed in claim 8, wherein the one or more predefined third parameters are internet usage, smartphone usage or mobile phone usage.

12. The system as claimed in claim 8, wherein for the determine the disease score the one or more processors are further configured to be capable of executing the programmed instructions stored in the memory to:
assign a score for each of the one or more predefined first parameters;
compute a disease value based on the score of each of the one or more predefined first parameters using a predefined first technique;
compare the disease value with each of one or more predefined disease value ranges, wherein each of the one or more predefined disease value ranges is associated with a category and a disease score; and
obtain the disease score corresponding to the matched predefined disease value range.

13. The system as claimed in claim 8, wherein for the determine the treatment score the one or more processors are further configured to be capable of executing the programmed instructions stored in the memory to:
assign a score for each of the one or more predefined second parameters;
compute a treatment value based on the score of each of the one or more predefined second parameter using a predefined second technique;
compare the treatment value with each of one or more predefined treatment value ranges, wherein each of the one or more predefined treatment value ranges is associated with a category and a treatment score; and
obtain the treatment score corresponding to the matched predefined treatment value range.

14. The system as claimed in claim 8, wherein for the determine the communication technology score the one or more processors are further configured to be capable of executing the programmed instructions stored in the memory to:
assign a score for each of the one or more predefined third parameters;
compute a communication technology value based on the score of each of the one or more predefined third parameter using a predefined third technique;
compare the communication technology value with each of one or more predefined communication technology value ranges, wherein each of the one or more predefined communication technology value ranges is associated with a category and a technology score; and
obtain the communication technology score corresponding to the matched predefined communication technology value range.

15. A non-transitory computer readable medium having stored thereon instructions for identifying an optimal communication mode and one or more health management modules for patient engagement comprising executable code which when executed by one or more processors, causes the processors to perform steps comprising:
receiving patient data of one or more patients in a region and communication technology data of one or more communication technologies prevalent in the region from one or more data sources;
determining a disease score for each of one or more diseases prevalent in the region based on one or more predefined first parameters associated with the patient data;
determining a treatment score for each of the one or more diseases prevalent in the region based on one or more predefined second parameters associated with the patient data;
determining a communication technology score based on one or more predefined third parameters associated with the communication technology data; and
identifying one or more health management modules based on the disease score and the treatment score and the optimal communication mode based on the communication technology score for the patient engagement.

16. The medium as claimed in claim 15, wherein the one or more predefined first parameters are type of disease, severity of the disease, awareness of the disease to the patient or demography of the patient.

17. The medium as claimed in claim 15, wherein the one or more predefined second parameters are medication adherence of the patient, number of additional diseases to the patient or expenditure by the patient for treatment of the disease and wherein the one or more predefined third parameters are internet usage, smartphone usage or mobile phone usage.

18. The medium as claimed in claim 15, wherein the determining the disease score comprises:
assigning a score for each of the one or more predefined first parameters;
computing a disease value based on the score of each of the one or more predefined first parameters using a predefined first technique;
comparing the disease value with each of one or more predefined disease value ranges, wherein each of the one or more predefined disease value ranges is associated with a category and a disease score; and
obtaining the disease score corresponding to the matched predefined disease value range.

19. The medium as claimed in claim 15, wherein the determining the treatment score further comprises:
assigning a score for each of the one or more predefined second parameters;
computing a treatment value based on the score of each of the one or more predefined second parameters using a predefined second technique;
comparing the treatment value with each of one or more predefined treatment value ranges, wherein each of the one or more predefined treatment value ranges is associated with a category and a treatment score; and
obtaining the treatment score corresponding to the matched predefined treatment value range.

20. The method as claimed in claim 15, wherein the determining the communication technology score further comprises:
assigning a score for each of the one or more predefined third parameters;
computing a communication technology value based on the score of each of the one or more predefined third parameters using a predefined third technique;
comparing the communication technology value with each of one or more predefined communication technology value ranges, wherein each of the one or more predefined communication technology value ranges is associated with a category and a communication technology score; and
obtaining the communication technology score corresponding to the matched predefined communication technology value range.
